(19) United States
(12) Patent Application Publication
(10) Pub. No.: US 2012/0290947 A1
(43) Pub. Date: Nov. 15, 2012

(54) METHODS AND SYSTEMS TO FILTER AND DISPLAY ELECTRONIC MESSAGES

(75) Inventors: David M. Baggett, Potomac, MD (US); Charles S. Pinnix, Silver Spring, MD (US); Andrew B. Goldberg, Columbia, MD (US); Simon Gregory Smith, Arlington, VA (US)

(73) Assignee: ARCODE CORPORATION, Bethesda, MD (US)

(21) Appl. No.: 13/445,900

(22) Filed: Apr. 12, 2012

Related U.S. Application Data
(60) Provisional application No. 61/474,562, filed on Apr. 12, 2011.

(51) Int. Cl. G06F 3/01; G06F 15/16

(52) U.S. Cl. 715/752

(57) ABSTRACT

Methods and systems to present a relatively small combinational set of user-selectable filter and display criteria, through a relatively small number of visually-intuitive controls of an electronic message (EM) graphical user interface (GUI), and to translate a combination of user-selected criteria to a more-complex set of configuration parameters. Methods and systems disclosed herein may be implemented to provide filter and/or display configurations on-par or greater than conventional EM clients, in quantity and/or complexity, with less user-effort, knowledge, and navigational skill.

### CROSS REFERENCE TO RELATED APPLICATIONS

This application claims the benefit of U.S. Provisional Patent Application No. 61/474,562, titled, “Electronic Messaging Interface,”filed Apr. 12, 2011, which is incorporated herein by reference in its entirety.

### BACKGROUND

An electronic mail (e-mail) environment may include an e-mail host to provide an e-mail to support multiple e-mail accounts, and e-mail clientsto permit e-mail account holders to interface with the e-mail host.The e-mail host may run on a server system. The e-mail clients may run local computer systems, physically remote from the e-mail host server system. E-mails may be stored on the e-mail server system and/or on the local computer systems.

An e-mail client may include configurable filter or search parameters to filter e-mails associated with an e-mail account. The e-mail client may also include configurable display parameters to control layout, sorting, and/or grouping of e-mailswithin a graphical user interface (GUI) of the e-mail client.

For example, an e-mail client may provide multiple selectable views, which may include a three-pane view having a folder tree pane, a message list pane, and a message preview pane.A two-pane view may omit the message preview pane. Views may be selectable through a menu bar.

A user may choose how messages should be sorted within the message list pane by clicking on a column header to reverse the current ordering. Displayed columns may be configurable through the menu bar. In other words, a user may have to go through the menu bar to add a desired column to the message pane, and return to the message pane to click on the heading of the newly-added column.

An e-mail client may provide several ways of grouping messages, such as a “View Threads,” where messages are grouped hierarchically according to reply relationships. Another example is a “View by Date” grouping.

An e-mail client may provide a conversation view, which may be similar to the threaded view in that replies are grouped with messages to which they reply. In the conversation view, the tree-structured hierarchy of who replied to whom is collapsed into a single level of indentation.

An e-mail client may provide message filtering from a view menu, such as by “threads with unread,”or by entering a search string into a search box.

In conventional e-mail clients, selection and/or configuration of filter and display parametersinvolves complex navigation through myriad click-able surfaces. The complexity and confusion may be result in inefficient and/or infrequent use of the features.

### SUMMARY

Disclosed herein are methods and systems to present a relatively small combinational set of user-selectable filter and display criteria, through a relatively small number of visually-intuitive controls of an electronic message (EM) graphical user interface (GUI), and to translate a combination of user-selected criteria to a more-complex set of configuration parameters. Methods and systems disclosed herein may be implemented to provide filter and/or display configurations on-par or greater than conventional EM clients, in quantity and/or complexity, with less user-effort, knowledge, and navigational skill.

### BRIEF DESCRIPTION OF THE DRA WINGS/FIGURES

FIG. 1 is a block diagram of an electronic message (EM) environment, including user devices to access EM accounts and an EM host to provide an EM environment for the EM accounts.

FIG. 2 is a block diagram of a user device, including a user interface system and an EM client to interface between the user interface system and an EM host.

FIG. 3 is a block diagram of anEM graphical user interface (GUI) system.

FIG. 4 is a screen shot of a GUI to interface between a user interface system and an EM store, including a first icon to display a drop-down window based pick-list of selectable filter criteria and a second icon to display a menu including selectable display options and a drop-down window based pick-list of selectable sort criteria.

FIG. 5 is a screen shot including a drop-down window based pick-list of selectable filter criteria.

FIG. 6 is a screen shot including a menu, including selectable display options and a drop-down window based pick-list of selectable sort criteria.

FIG. 7 is a screen shot of a scroll-wheel based pick-list.

FIG. 8 is a screen shot of a blended-view GUI to display EMs.

FIG. 9 is a flowchart of a method of interfacing between a user interface system and an EM store.

FIG. 10 is a block diagram of a computer system configured to interface between a user interface system and an EM store.

FIG. 11 is a screen shot of another GUI, including a multi-icon control bar, an editable search-term field 1104, and an EM pane 1106 to display filtered EMs.

FIG. 12 is a screen shot of the GUI of FIG. 11, including a pull-down menu of selectable filter criteria.

FIG. 13 is a screen shot of a portion of the GUI of FIG. 11, including a pull-down menu of selectable display criteria.

FIG. 14 is a screen shot of a portion of the GUI of FIG. 11, including a pull-down menu of selectable sort criteria.

FIG. 15 is a screen shot of a blended-view GUI, including an EM pane in which EMs are listed based on a combination of machine-assigned relevance or priority and time of receipt.

In the drawings, the leftmost digit(s) of a reference number identifies the drawing in which the reference number first appears.

### DETAILED DESCRIPTION

Disclosed herein are methods and systems to filter and display electronic messages (EMs), such as electronic mail (e-mail) messages. Methods and systems disclosed herein are not, however, limited to e-mail messages.

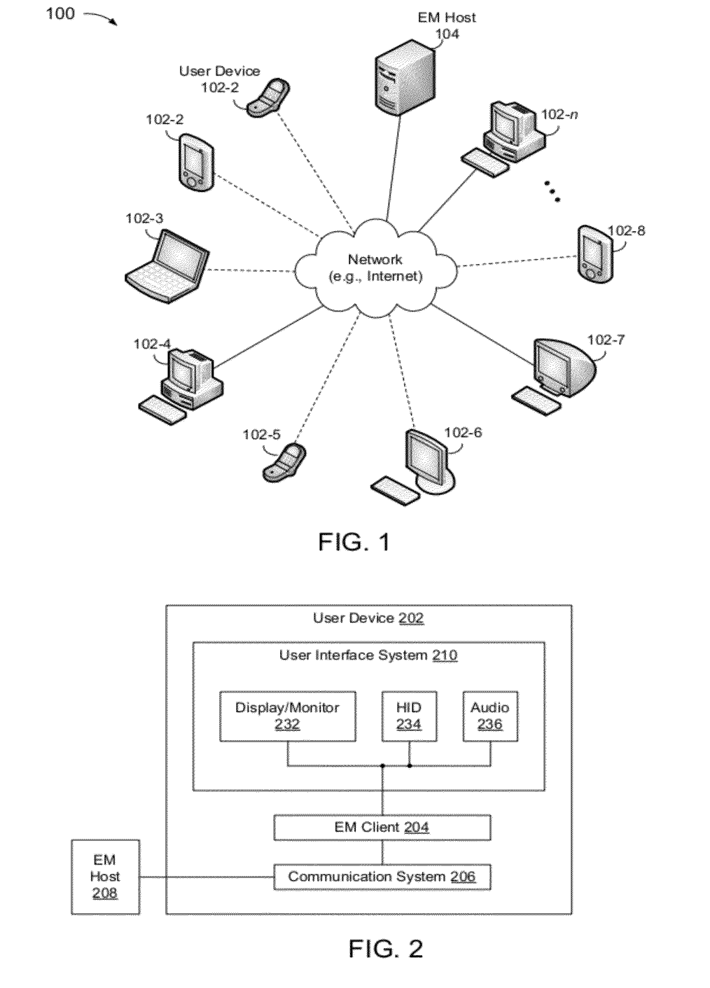

FIG. 1 is a block diagram of an electronic message (EM) environment 100, including user devices 102 to access EM accounts, and an EM host 104 to provide an EM environment for the EM accounts.

User devices 102 may each include a user interface system and an EM client to interface between the user interface system and EM host 104.

One or more of user devices 102 may be implemented as described below with reference to FIG. 2.

FIG. 2 is a block diagram of a user device 202, including a user interface system 210 and an EM client 204to interface between user interface system 210 and an EM host 208.

User device 202 may further include a communication system 206to communicate between EM client 204 and EM host 208. Communication system 206 may include a wired and/or wireless communication system, and may be implemented to communicate with the EM host 208 over a network, which may include a proprietary and/or public network, such as the Internet.

In the example of FIG. 2, user interface device 210 includes a monitor or display 232 to display a graphical user interface (GUI) of EM client 204.

User interface device 210 further includes a human interface device (HID) 234 to provide user input to EM client 204 through the GUI. HID 234 may include, for example and without limitation, a key board, a cursor device, a touch-sensitive device, a motion and/or image sensor, and/or or a microphone. HID 234 may include a physical device and/or a virtual device, such as a monitor-displayed keyboard or virtual keyboard.

User interface device 210 may further include an audio system 236 to provide audible information from EM client 204.

User device 202 may include a housing to hold EM client 204, communication system 206, and one or more user interface devices 210. The housing may include, without limitation, a rack-mountable housing, a desk-top housing, a lap-top housing, a notebook housing, a net-book housing, a set-top box housing, a portable housing such as a mobile telephone, and/or other conventional electronic housing and/or future-developed housing.

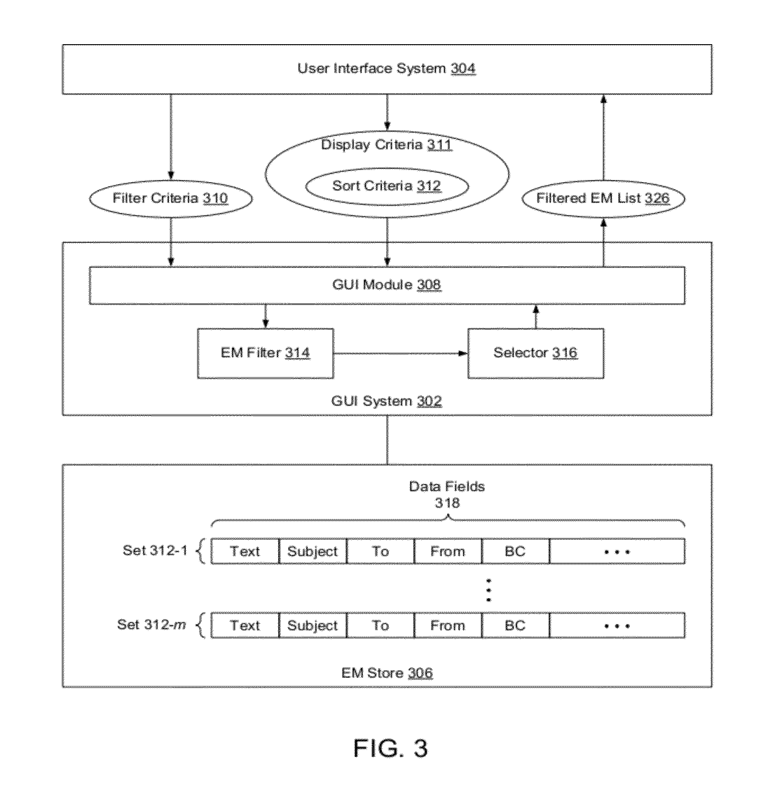

User device 202 and/or EM host 208 may include an EM storage system to store EMs, and EM client 204 and/or EM host 208 may include a GUI system to interface between user interface system 210 and the EM storage system,such as described below with reference to FIG. 3.

FIG. 3 is a block diagram of an EMGUI system 302 to interface between a user interface system 304 and an EM store 306. GUI system 302 may be implemented as, or within a machine, such as a computer system, integrated circuitry, and/or combinations thereof, and may be implemented in an EM client and/or an EM host.

GUI system 302 includes a GUI module 308 to provide a GUI to a display of user interface system 304, and to receive one or more filter criteria 310 and display criteria 311 from user interface system 304. In the example of FIG. 3, display criteria 311 include sort criteria 312. Display criteria 311 may further include layout criteria, grouping criteria, and/or font size criteriasuch as described in one or more examples herein.

GUI system 302 further includes afilter 314 to identify EMs of EM store 306 that satisfy filter criteria 310.

GUI system 302 further includes a selector 316 to select information to be displayed with filtered EMs based on filter criteria 310 and/or display criteria 311. Selector 316 may effectively translate a combination of user-selected criteria to a more-complex set of display parameters.

In the example of FIG. 3, EMs are each associated with, or stored as a corresponding set 312 of data fields 314. In this example, filter 314 may be implemented to search one or more of data fields 314 of the EMs based on filter criteria 310, and selector 316 may be implemented to select a subset of data fields 314 based filter criteria 310 and/or display criteria 311.

Selector 316 may be implemented to select a data field that is searched with respect to filter criteria 310, a data field to which sort criterion 312 is directed, and/or a data field to which a grouping criterion is directed.

Selector 316 may be implemented to exclude a data field from the subset of data fields when the data field is not searched with respect to filter criteria 312 and/or when the data field is not implicated or involved with display criteria 311. For example, data fields 314 may include a file-size data field, and selector 316 may exclude the file-size data field from the subset of data fields when filter criteria 310 and/or display criteria 311 does not include a file-size criterion.

As another example, GUI system 302 may be implemented to selectively include datesof receipt within list 326 when sort criteria 312 include a “sort by date” criterion.

As another example, GUI system 302 may be implemented to include dates of receipt within list 326 when display criteria 311 include a “display received messages” criterion, and to include dates of sending within list 326 when display criteria 311 include a “display sent messages” criterion and filter criteria 310 does not include a date-sent criteria.

GUI module 308 may be implemented to provide a list 326 of the identified EMs, including data selected by selector 316, in accordance with sort criteria 312.

GUI module 308 may be implemented to display an editable filter-term fieldwithin the GUI, and filter 314 may be implemented to search EMs and/or data fields 318 of the EMs based on a search term within filter criteria 312. Where filter criteria 310 includes a search term, “Subject: Project,” for example, filter 314 may search a “Subject” data field of the EMs for “Project.”

GUI 308 may be implemented to display a first pick-list of selectable filter criteria and a second pick-list of selectable sort criteria. GUI module 308 may be implemented to display first and second icons within a page of the GUI, to link to the respective first and second pick-lists. The first and/or second pick-list may include a pull-down menu and/or a scroll-wheel.

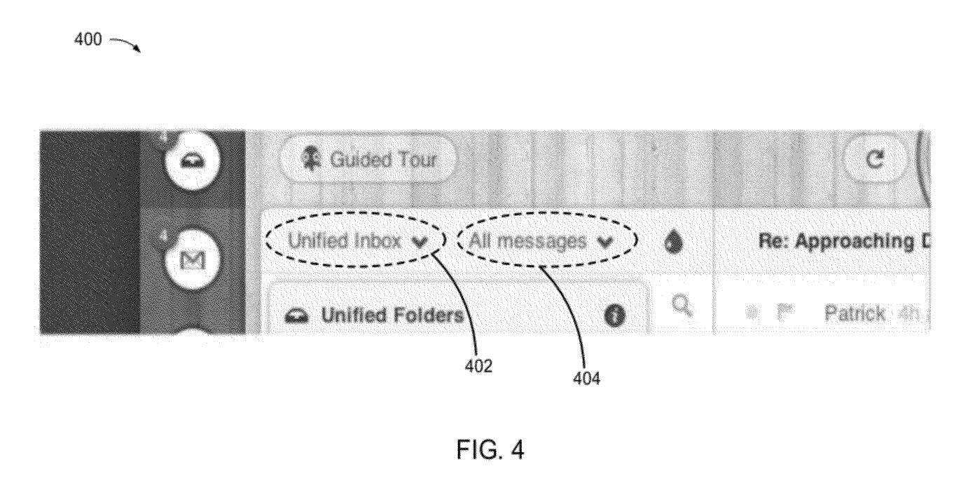

FIG. 4 is a screen shot of a portion of a GUI 400, including first and second icons 402 and 404. First icon 402 may serve as a link to selectable filter criteria, and second icon 404 may serve as a link to selectable display criteria. GUI 400 may further include an editable search field or window to receive a search/filter term or phrase.

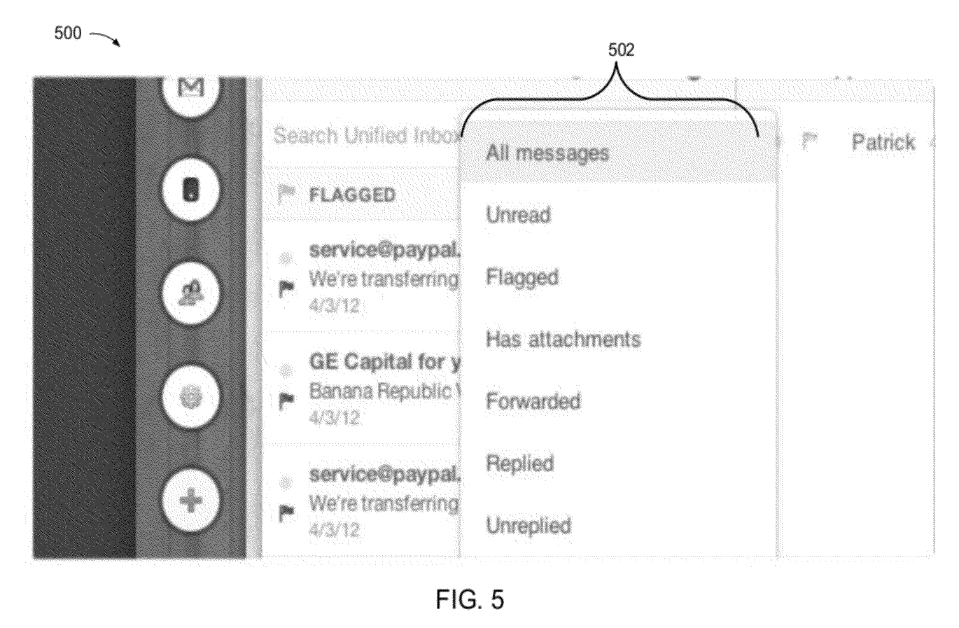

FIG. 5 is a screen shotof pick-list 502 of selectable filter criteria, illustrated here as a drop-down window, which may be displayed upon selection of first icon 402 in FIG. 4.

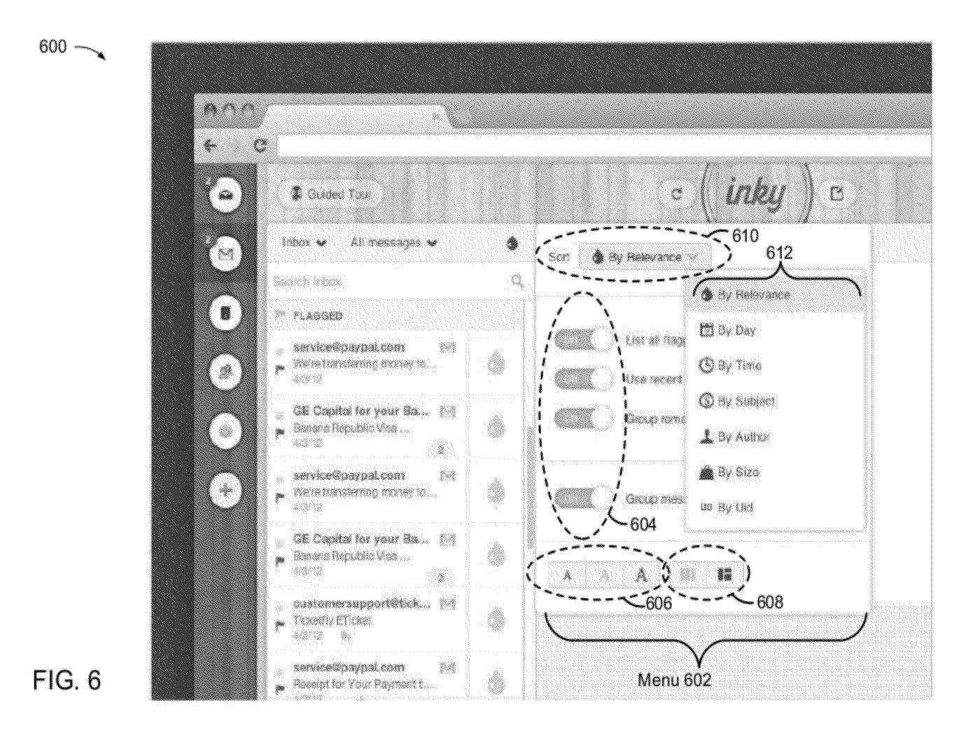

FIG. 6 is a screen shot of a menu 602 of selectable and/or configurable display parameters. In the example of FIG. 6, menu 602 includesgrouping options 604, font size options 606, and layout options 608.

Menu 602 further includesan icon 610 and a pick-list 612 of selectable sort criteria, illustrated here as a drop-down window. Pick-list 612 may be displayed upon selection of icon 610. Menu 602 may be displayed upon selection of second icon 404 in FIG. 4.

In an embodiment, GUI 400 of FIG. 4 may include an icon to provide a direct link to pick-list 612.

GUI 400 may further include a pick-list of selectable EM categories and/or groups, or an icon that links to a pick-list of selectable EM categories and/or groups.

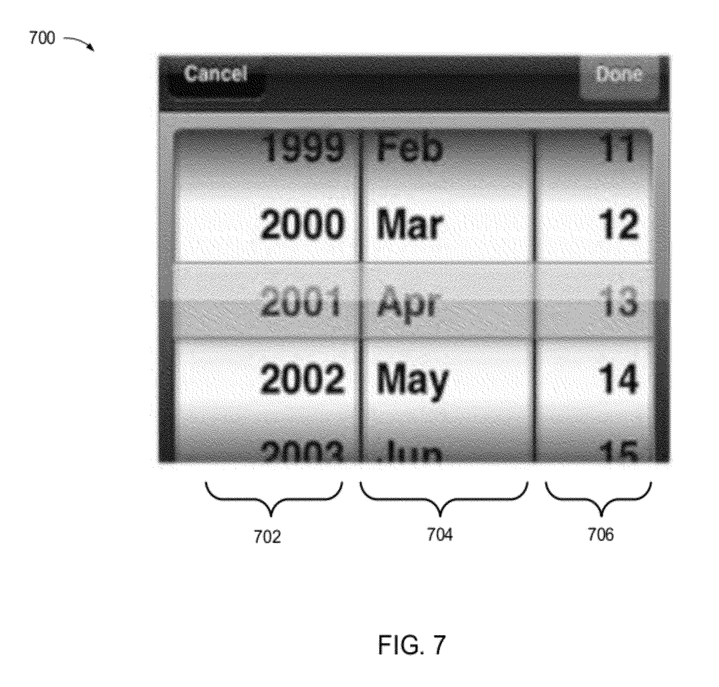

FIG. 7 is a screen shot of a pick-list 700, implemented as a scroll-wheel having multiple independently-scrollable wheels 702, 704, and 706. In the example of FIG. 7, wheels 702, 704, and 706 are implemented to select a date. Scroll-wheel based pick-lists are not, however, limited to this example. A scroll-wheel based pick-list may be useful, for example, with a touch-sensitive pad and/or display, which may be implemented in a mobile user devicesuch as a mobile communication and/or computing platform.

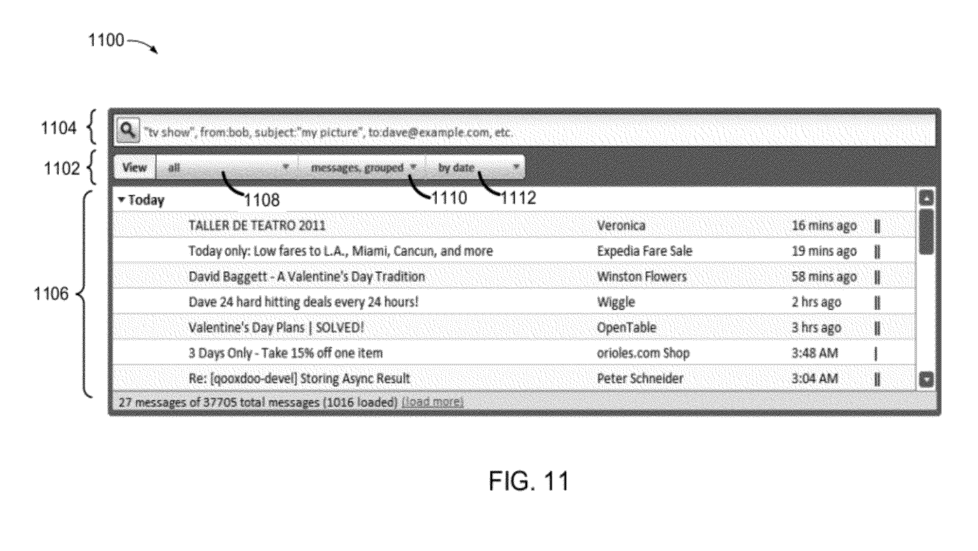

Additional example GUI screen shots are provided in FIG. 11 through below with FIG. 11, which are described further below.

In FIG. 3, filter criteria 310 may consist solely of a filter-term received from filter-term field of a GUI and/or one or more filter criteria selected from the first pick-list.

Filter 314 may be implemented to filter the EMs based solely filter criteria 310.

Sort criteria 312 may consist solely of sort criteria sort criteria selected from the second pick-list.

Selector 316 may be implemented to select the data to display based solely on filter criteria 310, display criteria 311, and/or sort criteria 312.

GUI module 308 may be implemented to display data solely from the selected subset of data fields. Alternatively, GUI module 308 may be implemented to display data from a default set of data fields and the selected subset of data fields.

GUI system 302 is not, however, limited to these examples.

GUI system 302 may be implemented and/or configurable to sort EMs based on a combination of a machine-assigned relevancy metric and one or more other criteria, referred to herein as a blended-view GUI.

A blended-view GUI may be configured to group EMs based on grouping criteria, and to sort or list the EMs within each group based on the relevancy metric.In this way, more-relevant or higher-priority EMs float to the top of the corresponding groups, while less-relevant or lower-priority EMs sink towards the bottom of the corresponding groups.

EMs may be grouped for example by arrival time, and EMs within each time-based group may be sorted by relevance or priority. As an example, EMs received today may be placed below the flagged EMs. EMs received on prior days may be grouped by day and placed below the EMs from today. Within each of the groups (i.e., EMs received today and EMs received on prior days), EMs are sorted based on corresponding machined-assigned relevancy or priority metrics. It groups messages by arrival time and by relevance.

Further to the example above, EMs having a user-assigned measure of importance or priority, such as a flag, may be placed at the top of list 326, and above the EMs received today.

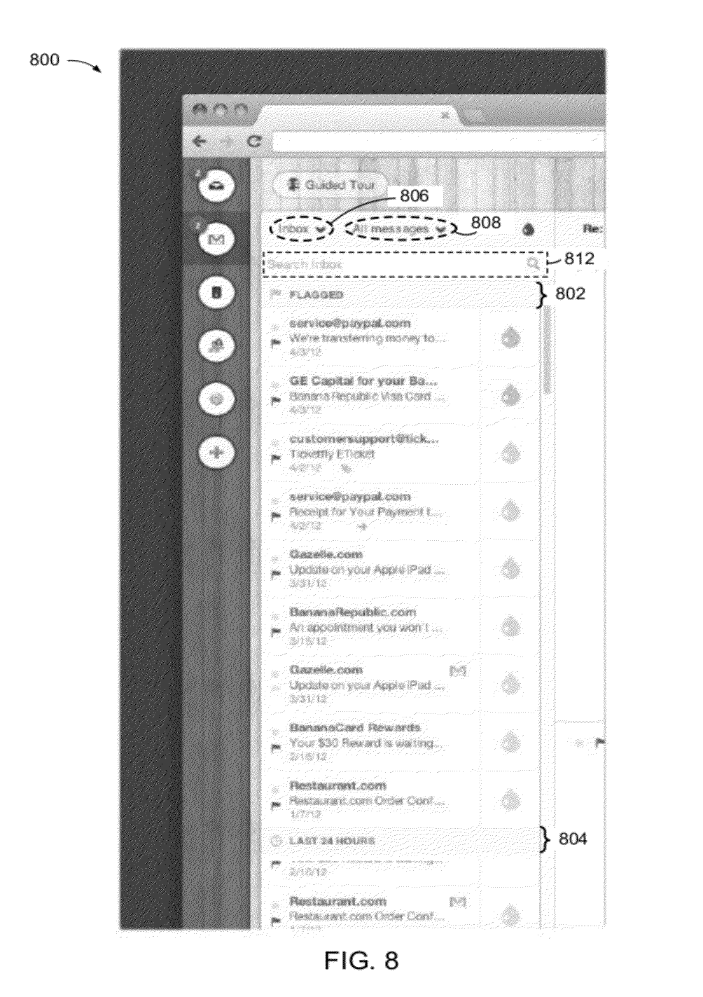

FIG. 8 is a screen shot of a portion of a blended-view GUI 800, where flagged EMs are listed (under a “Flagged” heading 802), above EMs received over the preceding 24 hours (listed under a “Last 24 Hours” heading 804).

Blended view GUI 800 further includes first and second icons 806 and 808, such as described above with reference to first and second icons 402 and 404 in FIG. 4.

Blended view GUI 800 further includes an editable search-term field 812, such as described further above.

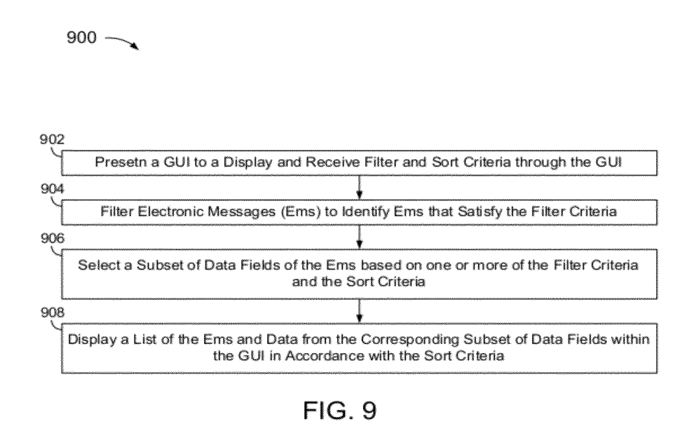

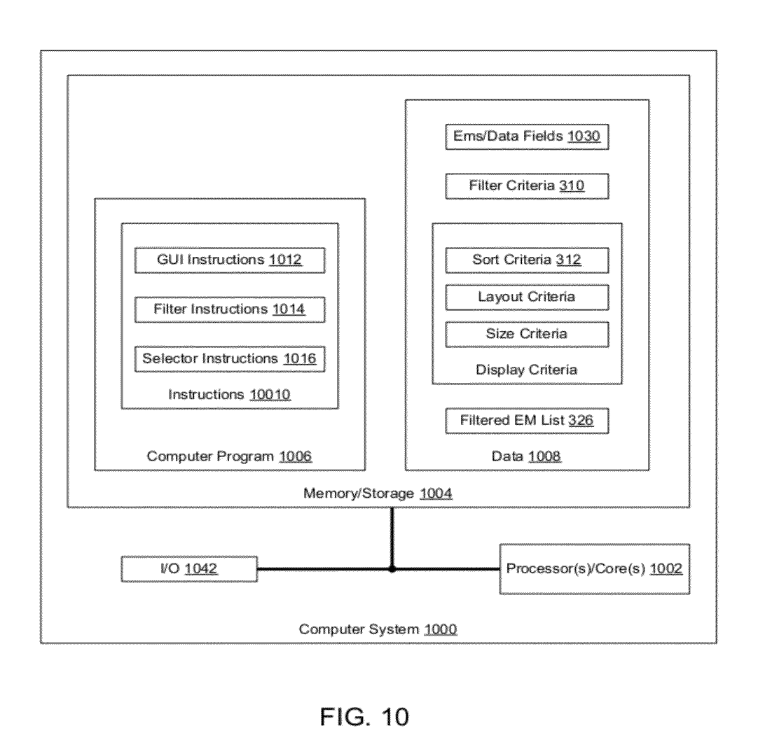

FIG. 9 is a flowchart of a method 900 of interfacing between a user interface system 304 and an EM store.Method 900 may be implemented with a system such as described above with reference to FIG. 3, and/or as described further below with reference to FIG. 10, and may be implemented at, or within an EM client and/or an EM host.

At 902, a GUI is presented to a display, and filter and display criteriaare received through the GUI, such as described above with respect to filter criteria 310 and display criteria 311.

At 904, EMs are filtered to identify EMs that satisfy the received filter criteria, such as described above with respect to filter 314 in FIG. 3.

At 906, data associated with the EMs is selected based on one or more of the received filter criteria and the received display criteria, such as described above with respect to selector 316 in FIG. 3.

At 908, a list of the identified EMs and the selected data are displayed within the

GUIin accordance with sort criteria received within the display criteria,such as described above with respect to GUI module 308 in FIG. 3.

Methods and systems disclosed herein may be implemented in hardware, software, firmware, and combinations thereof, including discrete and integrated circuit logic, application specific integrated circuit (ASIC) logic, and microcontrollers, and may be implemented as part of a domain-specific integrated circuit package, and/or a combination of integrated circuit packages. Software may include a computer readable medium encoded with a computer program including instructions to cause a processor to perform one or more functions in response thereto. The computer readable medium may include a transitory and/or non-transitory medium. The processor may include a general purpose instruction processor, a controller, a microcontroller, and/or other instruction-based processor.

FIG. 10 is a block diagram of a computer system 1000, configured to interface between a user interface system and a store of EMs 1030.

Computer system 1000 includes one or more computer instruction processing units and/or processor cores, illustrated here as a processor 1002, to execute computer readable instructions, also referred to herein as computer program logic and software.

Computer system 1000 may include memory, cache, registers, and/or storage, illustrated here generally as memory 1004, which may include a non-transitory computer readable medium encoded with a computer program, illustrated here as a computer program 1006, including instructions 1010.

Memory 1004 may include data 1008 to be used by processor 1002 in executing computer program 1006, and/or generated by processor 1002 during execution of computer program 1006.

In the example of FIG. 10, instructions 1010 include GUI instructions 1012 to cause processor 1002 to present a GUI to a display, and to receive filter criteria 310 and display criteria 311 through the GUI, such as described above with respect to GUI module 308 in FIG. 3.

Instructions 1010 further include filter instructions 1014 to cause processor 1002 to identify EMs that satisfy the received filter criteria, such as described above with respect to filter 314 in FIG. 3.

Instructions 1010 further include selector instructions 1016 to cause processor 1002 to a select data associated with the EMs based on one or more of filter criteria 310 and display criteria 311, such as described above with respect to selector 316 in FIG. 3.

GUI instructions 312 may include instructions to cause processor 1002 to display a list 326 of the identified EMs and the selected datawithin the GUIin accordance with sort criteria 312,such as described above with respect to GUI module 308 in FIG. 3.

Computer system 1000 may further include an input/output device 1042 to communicate with one or more other devices and/or systems, which may include one or more user interface devices, such as described above with reference to FIG. 2.

The additional example screen-shots of FIGS. 11 through 15 are now described.

FIG. 11 is a screen shot of a GUI 1100, including a control bar 1102 and an editable search-term field 1104, and an EM pane 1106 to display a list of EMs and selected data fields of the EMs.

Control bar 1102 includes a set of icons to provide individually-configurable controls, illustrated here as including a filter criteria icon 1108, a display criteria icon 1110, and a sort criteria icon 1112. Icons 1108, 1110, and 1112 are individually selectable to define multiple filter, display, and sort configurations.

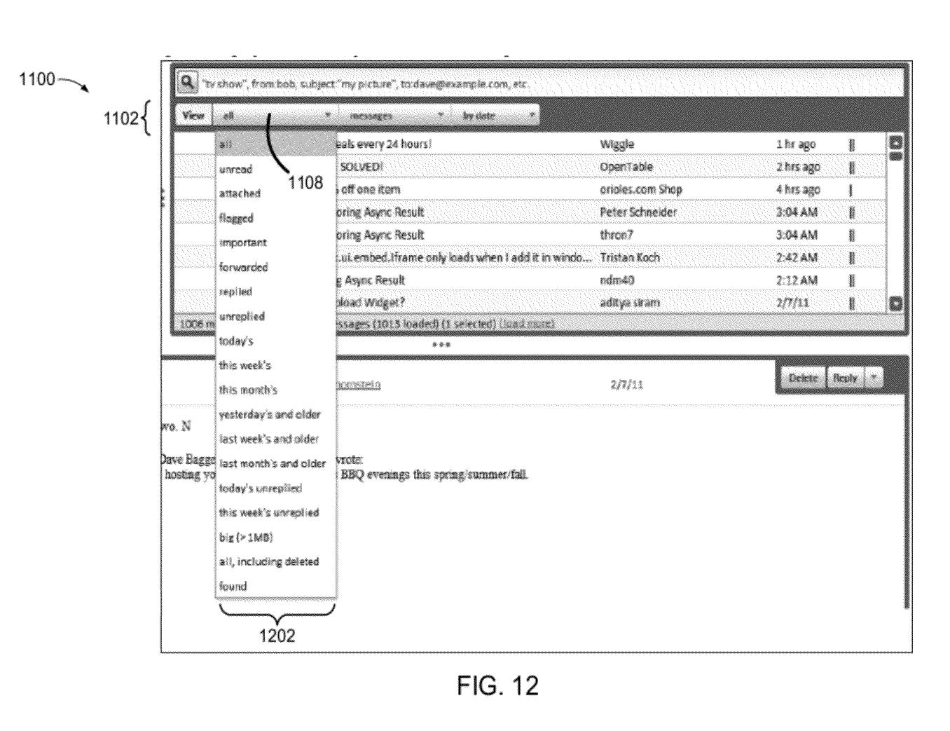

FIG. 12 is a screen shot of GUI 1100 including a pull-down menu 1202 of selectablefilter criteria. Menu 1202 may be activated upon selection of icon 1108 in FIG. 11.

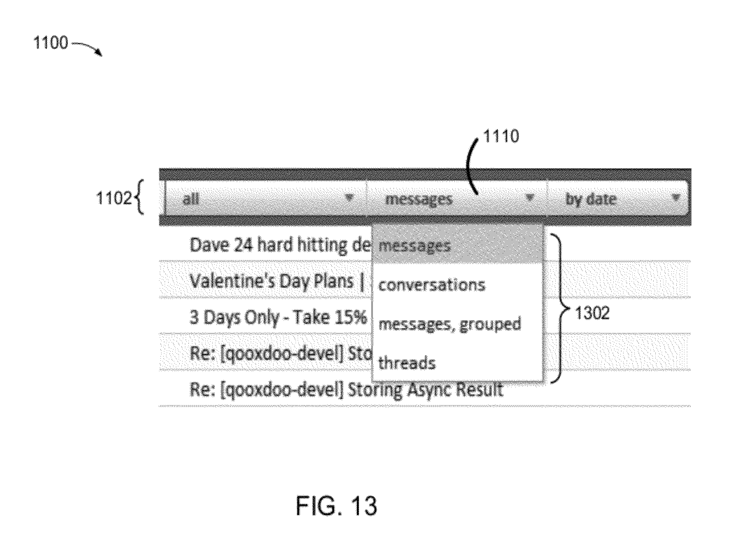

FIG. 13 is a screen shot of a portion of GUI 1100, including a pull-down menu 1302 of selectable display criteria. Menu 1302 may be activated upon selection of icon 1110 in FIG. 11.

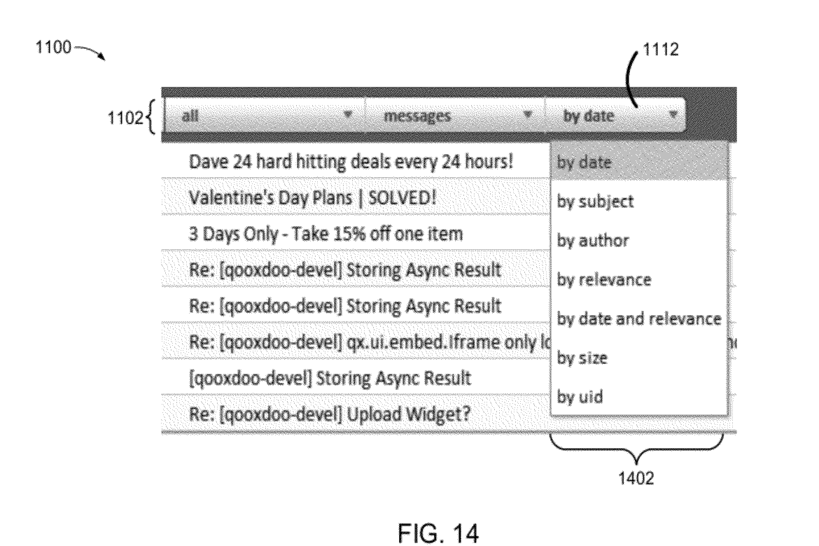

FIG. 14 is a screen shot of a portion of GUI 1100, including a pull-down menu 1402 of selectable sort criteria. Menu 1402 may be activated upon selection of icon 1112 in FIG. 11.

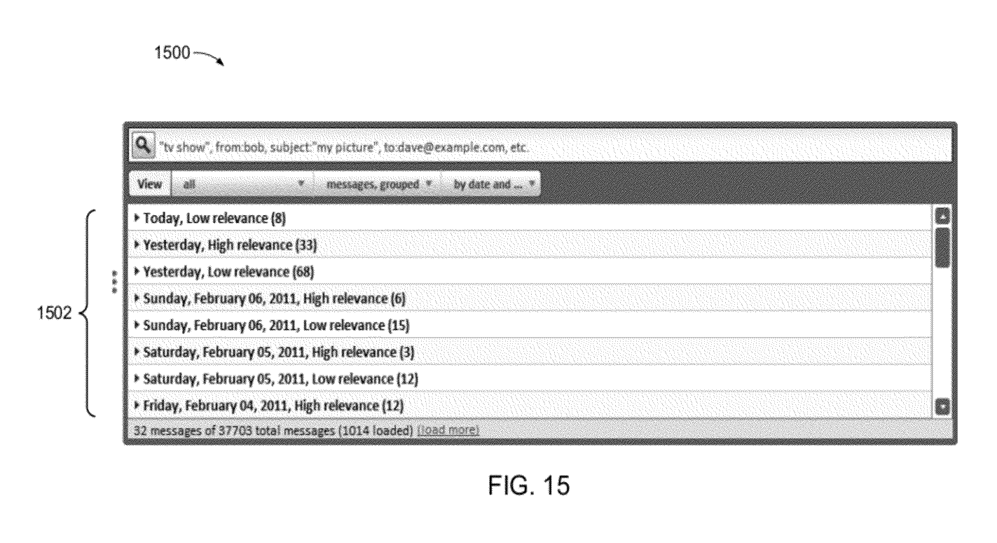

FIG. 15 is a screen shot of a blended-view GUI 1500, including an EM pane 1502 in which EMs are listed based on a combination of machine-assigned relevance or priority and time of receipt.

In FIG. 11, control bar 1102 is implemented to present configurationsof icons 1108, 1110, and 1112, with an intuitively readable, sentence-based syntax. In the example of FIG. 11, icons 1108, 1110, and 1112 are configured such that control bar 1108 reads, “view allmessages by date.” As another example, icons 1108, 1110, and 1112 may be configured such that control bar 1102 reads “view last month's and olderconversationsby relevance.” Many other configurations are possible.

Methods and systems are disclosed herein with the aid of functional building blocks illustrating the functions, features, and relationships thereof. At least some of the boundaries of these functional building blocks have been arbitrarily defined herein for the convenience of the description. Alternate boundaries may be defined so long as the specified functions and relationships thereof are appropriately performed.

While various embodiments are disclosed herein, it should be understood that they have been presented by way of example only, and not limitation. It will be apparent to persons skilled in the relevant art that various changes in form and detail may be made therein without departing from the spirit and scope of the methods and systems disclosed herein. Thus, the breadth and scope of the claims should not be limited by any of the example embodiments disclosed herein.

What is claimed is:

1. A system to filter electronic messages (EMs) and to display the filtered EMs, comprising:
a graphical user interface (GUI) module to present a GUI to a display and to receive filter and display criteria through the GUI, wherein the received display criteria include one or more sort criteria;
afilter to identify EMs that satisfy the received filter criteria; and
a selector to select a subset of data associated the EMs based on one or more of the received filter criteria and the received display criteria;
wherein the GUI module is implemented to display a list of the identified EMs and the subset of data within the GUIin accordance with the received sort criteria.

2. The system of claim 1, wherein the selector is implemented to select a data field that is searched with respect to the filter criteria.

3. The system of claim 1, wherein the selector is implemented to select a data field when the sort criterion is directed to the data field.

4. The system of claim 1, wherein the selector is implemented to exclude a data field from the subset of data fields when the data field is not searched with respect to the filter criteria and the sort criterion is not directed to the data field.

5. The system of claim 1, wherein the data fields include a file-size data field, and wherein the selector is implemented to exclude the file-size data field from the subset of data fields when the filter criteria does not include a file-size search criterion and the sort criteria does not include a sort by file-size criterion.

6. The system of claim 1, wherein the GUI module is implemented to:
display an editable filter-term fieldwithin the GUI;
display a first icon within a page of the GUI to display a first pick-list of selectable filter criteria upon selection of the first icon; and
display a second icon within the page of the GUI to display a second pick-list of selectable sort criteria upon selection of the second icon.

7. The system of claim 6, wherein the received filter criteria consist of one or more of a filter-term received from the filter-term field and one or more filter criteria selected from the first pick-list, wherein the received sort criteria consist of one or more filter criteria selected from the second pick-list, and wherein:
the filter is implemented to filter the electronic messages (EMs) based solely on the received the filter criteria;
the selector is implemented select the subset of data fields based solely on one or more of the received filter criteria and the sort criteria; and
the GUI module is implemented to display the list of identified EMs to include data from a default subset of the data fields and data from the selected subset of data fields.

8. The system of claim 6, wherein the GUI module is implemented to provide one or more of the first and second pick-lists as a pull-down menu.

9. The system of claim 6, wherein the GUI module is implemented to provide one or more of the first and second pick-lists as a scroll-wheel.

10. The system of any one of claims 1, wherein:
the GUI module is implemented to receive grouping criteria through the GUI;
the filter is implemented to filter the EMs based on the received filter and grouping criteria to identify EMs that satisfy the received filter and grouping criteria;
the selector is implemented to select the subset of data fields of the EMs based on one or more of the filter criteria, the sort criteria, and the grouping criteria; and
the GUI module is further implemented to display the list of the identified EMs to include data from the corresponding subset of data fieldsin accordance with the received sort and grouping criteria.

11. The system of claim 10, wherein the GUI module is further implemented to:
display the second icon within the GUI to display a menu upon selection of the second icon, wherein the menu includes selectable display options and a third icon to display the second pick-list of selectable sort criteria upon selection of the third icon.

12. The system of claim 10, wherein the GUI module is further implemented to:
display a third icon within the page of GUIto display a third pick-list of selectable display options upon selection of the third icon.

13. A machine-implemented method of filtering and displaying electronic messages (EMs), comprising:
presenting a GUI to a display and receiving filter and display criteria through the GUI, wherein the received display criteria includes one or more sort criteria;
filtering EMs to identify EMs that satisfy the received filter criteria;
selecting a subset of data associated with the EMs based on one or more of the received filter criteria and the received display criteria; and
displaying a list of the identified EMs and the corresponding subset of data within the GUIin accordance with the received sort criteria.

14. The method of claim 13, wherein selecting includes selecting a data field that is searched with respect to the filter criteria.

15. The method of claim 13, wherein the selecting includes selecting a data field when the sort criterion is directed to the data field.

16. The method of claim 13, further including:
excluding a data field from the subset of data fields when the data field is not searched with respect to the filter criteria and the sort criterion is not directed to the data field.

17. The method of claim 13, wherein the data fields include a file-size data field, the method further including:
excluding the file-size data field from the subset of data fields when the filter criteria does not include a file-size filter criterion and the sort criteria does not include a sort by file-size criterion.

18. The method of claim 13, further including:
displaying an editable filter-term fieldwithin the GUI;
displaying a first icon within a page of the GUI, and displaying a first pick-list of selectable filter criteria upon selection of the first icon; and
displaying a second icon within the page of the GUI, and displaying a second pick-list of selectable sort criteria upon selection of the second icon.

19. The method of claim 18, wherein the received filter criteria consist solely of one or more of a filter-term received from the filter-term field and one or more filter criteria selected from the first pick-list, wherein the received sort criteria consist solely of one or more filter criteria selected from the second pick-list, and wherein:
the filtering includes filtering the electronic messages (EMs) based solely on the received the filter criteria;
the selecting includes selecting the subset of data fields based solely on one or more of the received filter criteria and the sort criteria; and
the displaying includes displaying the list of identified EMs to include data from a default subset of the data fields and data from the selected subset of data fields.

20. The method of claim 18, further includingpresenting one or more of the first and second pick-lists as a pull-down menu.

21. The method of claim 18, further includingpresenting one or more of the first and second pick-lists as a scroll-wheel.

22. The method of claim 13, wherein:
the receiving includes receiving grouping criteria through the GUI;
the filtering includes filtering the EMs based on the received filter and grouping criteria to identify EMs that satisfy the received filter and grouping criteria;
the selecting includes selecting the subset of data fields of the EMs based on one or more of the filter criteria, the sort criteria, and the grouping criteria; and
the displaying includes displaying the list of the identified EMs and data from the corresponding subset of data fields in accordance with the received sort and grouping criteria.

23. The method of claim 22, wherein the displaying includes:
displaying the second icon within the GUI, and displaying a menu upon selection of the second icon, wherein the menu includes selectable display options and a third icon to display the second pick-list of selectable sort criteria upon selection of the third icon.

24. The method of claim 22, wherein the displaying includes:
displaying a third icon within the page of GUI to display a third pick-list of selectable display options upon selection of the third icon.

25. A non-transitory computer readable medium encoded with a computer program, including instructions to cause a processor to:
receive filter and display criteria through a graphical user interface (GUI), wherein the received display criteria includes one or more sort criteria;
filter electronic messages (EMs) based on the received filter criteria to identify EMs that satisfy the received filter criteria;
select a subset of data associated with the EMs based on one or more of the received filter criteria and the received display criteria; and
display a list of the identified EMs and the corresponding subset of data within the GUIin accordance with the received sort criteria.

26. The computer readable medium of claim 25, wherein the instructions to select a subset of data include instructions to cause the processor to select a data field that is searched with respect to the filter criteria.

27. The computer readable medium of claim 25, wherein the sort criteria include a sort criterion, and wherein the instructions to select a subset of the data fields include instructions to cause the processor to select a data field when the sort criterion is directed to the data field.

28. The computer readable medium of claim 25, wherein the sort criteria include a sort criterion, and wherein the instructions to select a subset of the data fields include instructions to cause the processor to exclude a data field from the subset of data fields when the data field is not searched with respect to the filter criteria and the sort criterion is not directed to the data field.

29. The computer readable medium of claim 25, wherein the data fields include a file-size data field, and wherein the instructions to select a subset of the data fields include instructions to cause the processor to exclude the file-size data field from the subset of data fields when the filter criteriadoes not include a file-size search criterion and the sort criteriadoes not include a sort by file-size criterion.

30. The computer readable medium of claim 25, wherein the instructions further include instructions to cause the processor to:
display an editable filter-term field within a page of the GUI;
display a first icon within the page of the GUI to display a first pick-list of selectable filter criteria upon selection of the first icon;
display a second icon within the page of the GUI to display a second pick-list of selectable sort criteria upon selection of the second icon.

31. The computer readable medium of claim 30, whereinthe received filter criteria consist of one or more of a filter-term received from the filter-term field and one or more filter criteria selected from the first pick-list, wherein the received sort criteria consist of one or more filter criteria selected from the second pick-list, and wherein the instructions further include instructions to cause the processor to:
filter the electronic messages (EMs) based solely on the received the filter criteria;
select the subset of data fields based solely on one or more of the received filter criteria and the sort criteria; and
display the list of identified EMs, including data from a default subset of the data fields and data from the selected subset of data fields, within the GUI and in accordance with the received sort criteria.

32. The computer readable medium of claim 30, further including instructions to cause the processor to present one or more of the first and second pick-lists as a pull-down menu.

33. The computer readable medium of claim 30, further including instructions to cause the processor to present one or more of the first and second pick-lists as a scroll-wheel.

34. The computer readable medium of claim 25, further including instructions to cause the processor to:
receive grouping criteria through the GUI;
filter the EMs based on the received filter and grouping criteria to identify EMs that satisfy the received filter and grouping criteria;
select the subset of data fields of the EMs based on one or more of the filter criteria, the sort criteria, and the grouping criteria; and
display the list of the identified EMs, including data from the corresponding subset of data fields, within the GUI and in accordance with the received sort and grouping criteria.

35. The computer readable medium of claim 34, wherein the instructions further include instructions to cause the processor to:
display the second icon within the page of the GUI to display a menu upon selection of the second icon, wherein the menu includes selectable display options and a third icon to display the second pick-list of selectable sort criteria upon selection of the third icon.

36. The computer readable medium of claim 34, wherein the instructions further include instructions to cause the processor to:
display a third icon within the page of GUI to display a third pick-list of selectable display options upon selection of the third icon.
